(19) United States
(12) Patent Application Publication
(10) Pub. No.: US 2020/0333658 A1
(43) Pub. Date: Oct. 22, 2020

(54) LIQUID CRYSTAL DISPLAY

(71) Applicant: InnoLux Corporation, Miao-Li County (TW)

(72) Inventors: Yu-Chia Huang, Miao-Li County (TW); Yuan-Lin Wu, Miao-Li County (TW); Kuan-Feng Lee, Miao-Li County (TW); Tsung-Han Tsai, Miao-Li County (TW)

(21) Appl. No.: 16/390,008

(22) Filed: Apr. 22, 2019

(51) Int. Cl. G02F 1/1335; G02F 1/1333; F21V 8/00

(52) U.S. Cl. CPC G02F 1/133504; G02F 1/133305; G02F 1/1368; G02B 6/0045; G02F 2001/133567; G02F 1/133528

(57) ABSTRACT

A liquid crystal display includes a first flexible substrate, a second flexible substrate, a liquid crystal layer, and an optical film. The liquid crystal layer is disposed between the first flexible substrate and the second flexible substrate. The optical film is adhered to the first flexible substrate, and the optical film includes a polarizing layer and a diffusing layer adhered to the polarizing layer.

### BACKGROUND OF THE DISCLOSURE

### 1. Field of the Disclosure

The present disclosure is related to a liquid crystal display, and more particularly, to a flexible liquid crystal display.

### 2. Description of the Prior Art

In recent years, flexible or deformable electronic devices have become one of focuses in the new generation electronic technology. The demand of the flexible display device that can be integrated in the electronic device is therefore increased. A flexible display device means the device can be flexed, curved, folded, stretched, rolled, or the like. In the conventional flexible display device, separated layers or films (such as optical layers or optical films in the backlight module) may have inconsistent curvatures when the flexible display device is curved, and problems such as peeling, misalignment, or uneven gaps between these layers may occur, thereby degrading the brightness uniformity of the flexible display device. Therefore, it is an important issue for the manufacturers to improve the brightness uniformity of the flexible display device.

### SUMMARY OF THE DISCLOSURE

To solve the above technical problem, one of the objectives of the present disclosure is to provide a flexible liquid crystal display and related electronic device, wherein the flexible liquid crystal display includes an optical film integrated with a flexible substrate.

In some embodiments, the liquid crystal display includes a first flexible substrate, a second flexible substrate, a liquid crystal layer, and an optical film. The liquid crystal layer is disposed between the first flexible substrate and the second flexible substrate. The optical film is adhered to the first flexible substrate, and the optical film includes a polarizing layer and a diffusing layer adhered to the polarizing layer.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a side-view schematic diagram illustrating an electronic device or a liquid crystal display according to a first embodiment of the present disclosure.

FIG. 2 is a top-view schematic diagram illustrating a first flexible substrate and an optical film according to the first embodiment.

FIG. 3 is a side-view schematic diagram illustrating an enlargement of a portion of the electronic device or the liquid crystal display according to the first embodiment.

FIG. 4 is a side-view schematic diagram illustrating an electronic device or a liquid crystal display according to a second embodiment of the present disclosure.

FIG. 5 is a side-view schematic diagram illustrating an electronic device or a liquid crystal display according to a third embodiment of the present disclosure.

FIG. 6 is a side-view schematic diagram illustrating an electronic device or a liquid crystal display according to a fourth embodiment of the present disclosure.

FIG. 7 is a side-view schematic diagram illustrating an electronic device or a liquid crystal display according to a fifth embodiment of the present disclosure.

FIG. 8 is a side-view schematic diagram illustrating an electronic device or a liquid crystal display according to a sixth embodiment of the present disclosure.

FIG. 9 is a side-view schematic diagram illustrating an electronic device or a liquid crystal display according to a seventh embodiment of the present disclosure.

FIGS. 10-12 are schematic diagrams illustrating a method of manufacturing an electronic device or a liquid crystal display according to an eighth embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the electronic device or liquid crystal display, and certain elements in various drawings may not be drawn to scale. In addition, the number and dimension of each device shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include”, “comprise” and “have” are used in an open-ended fashion, and thus should be interpreted to mean “include, but not limited to . . . ”.

It will be understood that when an element or layer is referred to as being “on” or “connected to” another element or layer, it can be directly on or directly connected to the other element or layer, or intervening elements or layers may be presented. In contrast, when an element is referred to as being “directly on” or “directly connected to” another element or layer, there are no intervening elements or layers presented.

It should be noted that the technical features in different embodiments described in the following can be replaced, recombined, or mixed with one another to constitute another embodiment without departing from the spirit of the present disclosure.

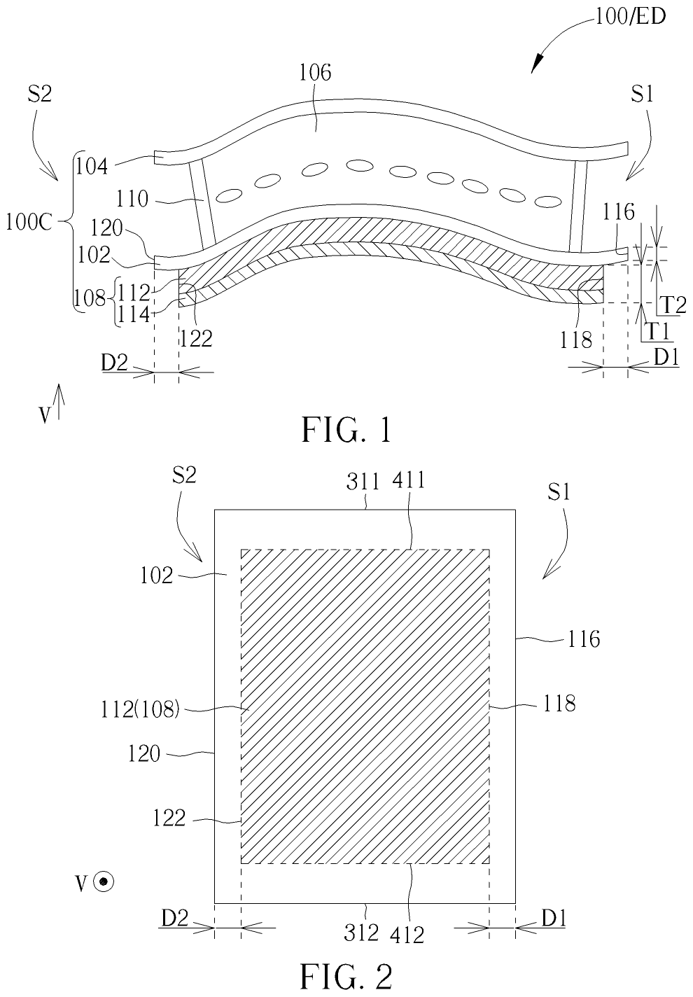

Referring to FIG. 1, it is a side-view schematic diagram illustrating an electronic device or a liquid crystal display according to a first embodiment of the present disclosure. For ease of explanation, some components in the electronic device or the liquid crystal display are omitted in figures of the present disclosure, for example, signal lines, thin film transistors, metal layers, insulating layers circuits and/or some optical layers are omitted in FIG. 1. In addition, the electronic device ED in various embodiments of the present disclosure may be a flexible electronic device. As an example, the flexible electronic device may include a liquid crystal display 100 that could display images, and the liquid crystal display 100 may be a flexible liquid crystal display. The term “flexible” used for describing the flexible liquid crystal display or the flexible electronic device means that at least a part of the flexible liquid crystal display or the flexible electronic device could be flexed, curved, bended, folded, stretched, and/or rolled. For example, a portion of the flexible liquid crystal display may be flexed, curved, bended, folded, stretched, and/or rolled along one or more directions, but not limited thereto. Alternatively, according to some embodiments, the flexible electronic device may have no display function, for example, may include an antenna, such as a liquid crystal antenna. For ease of explanation, embodiments when the flexible electronic device is the flexible liquid crystal display are taken for examples in the present disclosure.

Referring to FIG. 1, the liquid crystal display 100 (or the electronic device ED) may include a first flexible substrate 102, a second flexible substrate 104, a liquid crystal layer 106, and an optical film 108. The liquid crystal layer 106 is disposed between the first flexible substrate 102 and the second flexible substrate 104. Additionally, the flexible liquid crystal display 100 may further include a sealant 110 disposed at the periphery of the liquid crystal display 100, but not limited thereto. The liquid crystal layer 106 is sealed by the sealant 110 between the first flexible substrate 102 and the second flexible substrate 104, thus forming a cell. In some embodiments, after the cell is formed, the optical film 108 can be adhered to the first flexible substrate 102, thus forming a display panel 100C. Therefore, the display panel 100C may include the first flexible substrate 102, the second flexible substrate 104, the liquid crystal layer 106, and the optical film 108. The optical film 108 can include a polarizing layer 112 and a diffusing layer 114. The polarizing layer 112 can be disposed between the first flexible substrate 102 and the diffusing layer 114, and the diffusing layer 114 can be adhered to the polarizing layer 112. The term “adhere” in the present disclosure can refer to directly contact by adhesive or directly contact without adhesive. In some embodiments, a layer may be adhered to another layer by the adhesive material (such as glue). In some embodiments, a layer may be adhered to another layer by coating, for example, a layer may be directly coated on another layer by coating method. For example, in FIG. 1, the optical film 108 may be directly contacted with the first flexible substrate 102, and the diffusing layer 114 may be directly contacted with the polarizing layer 112.

In some embodiments, the diffusing layer 114 is adhered to the polarizing layer 112. Thus, the polarizing layer 112 and the diffusing layer 114 are integrated into the optical film 108. The integrated optical film 108 can be adhered to the first flexible substrate 102 to form the display panel 100C. Therefore, when the display panel 100C is curved, the diffusing layer 114 and the polarizing layer 112 in the optical film 108 may be curved along with the first flexible substrate 102. As shown in FIG. 1, the liquid crystal display 100 may be curved or flexed to have undulate shape, but not limited thereto. A curvature radius of the first flexible substrate 102 may be substantially equal to a curvature radius of the optical film 108, or the curvature radius of the first flexible substrate 102 may be substantially equal to a curvature radius of the diffusing layer 114 and/or a curvature radius of the polarizing layer 112. Thus, when the display panel 100C is curved, the adhesion between the first flexible substrate 102 and the optical film 108 can be more stable, and/or the adhesion between the polarizing layer 112 and the diffusing layer 114 can be more stable. Thus, peeling between the first flexible substrate 102 and the optical film 108 can be prevented, and/or peeling between the polarizing layer 112 and the diffusing layer 114 can be prevented. In addition, in some embodiments, problems such as peeling, misalignment, or uneven gaps between layers may be reduced when the liquid crystal display 100 is curved, and the brightness uniformity of the flexible liquid crystal display 100 may be improved.

In some embodiments, a thickness T1 of the optical film 108 is greater than or equal to a thickness T2 of the first flexible substrate 102. For example, the thickness T1 of the optical film 108 may be in a range from 100 micrometers to 1000 micrometers, and the thickness T2 of the first flexible substrate 102 (and/or the second flexible substrate 104) may be in a range from 10 micrometers to 200 micrometers. In another aspect, a Young's modulus of the optical film 108 may be greater than a Young's modulus of the first flexible substrate 102 (and/or the second flexible substrate 104). Accordingly, the optical film 108 can provide better supporting function to the first flexible substrate 102 and/or the liquid crystal display 100.

In some embodiments, at least one edge on one side of the first flexible substrate 102 (and/or the second flexible substrate 104) may be protruded out of an edge of the optical film 108. For example, as shown in FIG. 1, in some embodiments, a first edge 116 of the first flexible substrate 102 may be protruded out of a second edge 118 of the optical film 108 by a protruded distance D1. The second edge 118 is adjacent to the first edge 116, and the first edge 116 and the second edge 118 are on the same side (S1) of the liquid crystal display 100. In some embodiments, a third edge 120 of the first flexible substrate 102, which is opposite to the first edge 116, may be protruded out of a fourth edge 122 of the optical film 108 by a protruded distance D2, but not limited thereto. The third edge 120 and the fourth edge 122 are adjacent, and on the same side (S2) of the liquid crystal display 100. For example, the protruded distance D1 and the protruded distance D2 can be independently in a range from 0.5 millimeters to 5 centimeters. In some embodiments, the distances D1 and D2 may be in a range from 0.5 millimeters to 5 millimeters. The protruded distances D1 and D2 can be the same or different. The length of the first flexible substrate 102 (and/or the second flexible substrate 104) may be greater than the length of the optical film 108, but not limited thereto. In addition, as shown in FIG. 1, a normal direction V may be a direction perpendicular to a top surface of the first flexible substrate 102, and the distances D1 and D2 may be measured in a transverse direction perpendicular to the normal direction V, but not limited thereto. In addition, although not shown in figures, in some embodiments, on the same side, an edge (for example, 116) of the first flexible substrate 102 may not be protruded out of the corresponding edge (for example, 118) of the optical film 108, and may be aligned with the edge 118 of the optical film 108.

Still referring to FIG. 1, FIG. 1 shows that two edges 116 and 120 of the first flexible substrate 102 are protruded out of the two edges 118 and 122 of the optical film 108 respectively. However, in some embodiments, only one edge of the first flexible substrate 102 is protruded out of the corresponding edge of the optical film 108. For example, the first edge 116 of the first flexible substrate 102 may be protruded out of the second edge 118 of the optical film 108, but the third edge 120 of the first flexible substrate 102 may not be protruded out of the fourth edge 122 of the optical film 108. In some embodiments, the first edge 116 of the first flexible substrate 102 may be protruded out of the second edge 118 of the optical film 108, and the third edge 120 of the first flexible substrate 102 may be aligned with the fourth edge 122 of the optical film 108.

Also, referring to FIG. 2, it is a top-view schematic diagram illustrating a first flexible substrate and an optical film according to the first embodiment. FIG. 2 shows that on four sides, the four edges (116, 120, 311, 312) of the first flexible substrate 102 is protruded out of the corresponding four edges (118, 122, 411, 412) of the optical film 108, but not limited to. The protruded distances can refer to the descriptions related to the distances D1 and D2. An area of the first flexible substrate 102 (and/or the second flexible substrate 104) may be different from an area of the optical film 108. As shown in FIG. 2, the area of the first flexible substrate 102 (and/or the second flexible substrate 104) may be greater than the area of the optical film 108, or the first flexible substrate 102 (and/or the second flexible substrate 104) may completely cover the optical film 108, but not limited thereto. For example, a ratio of the area of the first flexible substrate 102 (and/or the second flexible substrate 104) to the area of the optical film 108 may be greater than 1 and less than or equal to 1.2. Therefore, the first flexible substrate 102 (and/or the second flexible substrate 104) may have the buffer area for shrinking or expanding when it is flexed, or the problem of misalignment with the optical film 108 may be reduced. Additionally, in some embodiments (not shown), the first flexible substrate 102 (and/or the second flexible substrate 104) may not completely cover the optical film 108, and a portion of the optical film 108 may be exposed. In some embodiments, the first flexible substrate 102 and the second flexible substrate 104 can have the same area, or can have different areas.

The first flexible substrate 102 (and/or the second flexible substrate 104) may comprise polyimide (PI), polyethylene terephthalate (PET), or other suitable transparent plastic materials. The polarizing layer 112 may include the single layer structure or multilayer structure. In some embodiments, the polarizing layer 112 may include two protective films and one polarizing film, and the polarizing film may be disposed between the two protective films. For example, one of the protective films may be used to maintain the stress balance in the polarizing layer 112, and the other one of the protective films may be used to adjust the phase difference of the light, but not limited thereto. In some embodiments, the polarizing layer 112 may include one protective film and one polarizing film, and the polarizing film may be disposed on one side of the protective film. In some embodiments, the polarizing layer 112 may include a polarizing film. For example, triacetyl cellulose (TAC), polyethylene terephthalate (PET), cycloolefin polymer (COP), or a structure in which these materials are stacked may be used as the protective film, but not limited thereto. For example, polyvinyl alcohol (PVA) may be used as a main component and a material in which iodine (I) compound molecules are adsorbed and oriented as the polarization element, but not limited thereto.

A layer that can diffuse or refract light may be used as the diffusing layer 114. In some embodiments, the diffusing layer 114 may comprise PVA, TAC, PET, COP, silicon oxide (SiOₓ), silicon nitride (SiNₓ), aluminium oxide (AlOₓ), hard coating materials, or a combination thereof, but not limited thereto. In some embodiments, the diffusing layer 114 may include a plurality of microstructures disposed on the surface of the diffusing layer 114. For example, the diffusing layer 114 may include a plurality of triangle or pyramid-shape microstructures, but not limited thereto. In some embodiments, the above microstructures may be directly formed on the surface of the polarizing layer 112 to provide diffusing function, but not limited thereto.

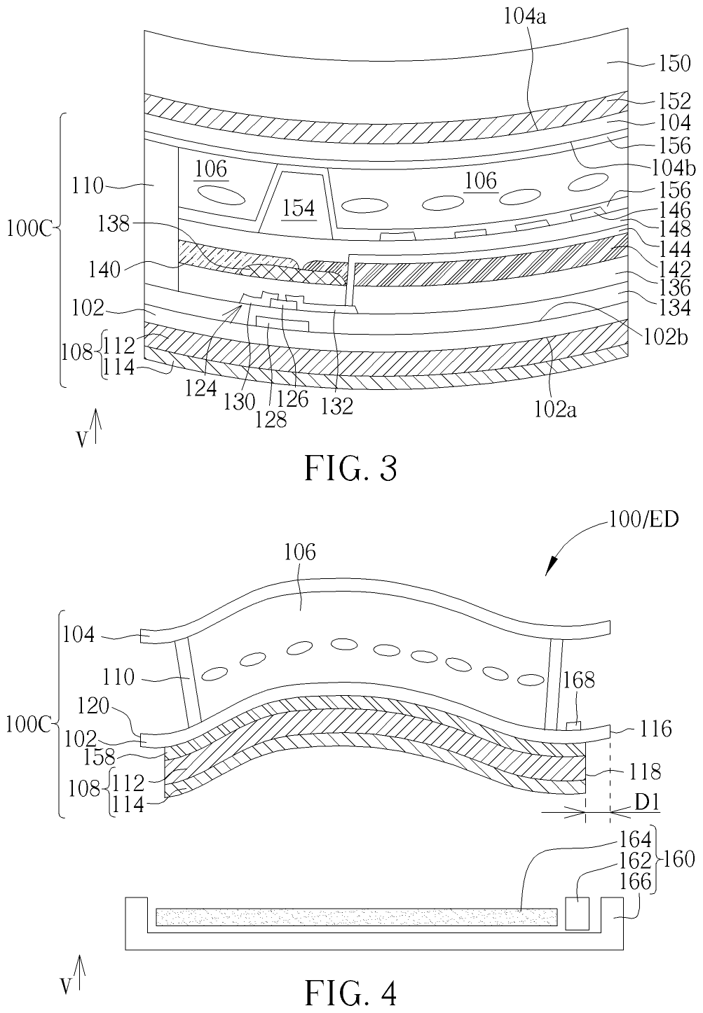

Referring to FIG. 3, it is a side-view schematic diagram illustrating an enlargement of a portion of the electronic device or the liquid crystal display according to the first embodiment. In FIG. 3, the optical film 108 may be adhered to an outer surface 102a of the first flexible substrate 102, and a thin film transistor (TFT) 124 may be disposed on an inner surface 102b of the first flexible substrate 102. The inner surface 102b means the surface facing toward the interior of the display panel 100C and facing to the liquid crystal layer 106, and the outer surface 102a means the surface away from the liquid crystal layer 106. The outer surface 102a is opposite to the inner surface 102b. The TFT 124 may include a semiconductor layer 126, a gate electrode 128, a source electrode 130 and a drain electrode 132. The semiconductor layer 126 may be disposed on the gate electrode 128, and an insulating layer 134 may be disposed between the semiconductor layer 126 and the gate electrode 128. The TFT 124 can be a bottom gate structure as shown in FIG. 3, or can be a top gate structure (not shown). The source electrode 130 may be electrically connected to one side of the semiconductor layer 126, and the drain electrode 132 may be electrically connected to another side of the semiconductor layer 126. An insulating layer 136 may cover the semiconductor layer 126, the source electrode 130, and the drain electrode 132. A shielding member 138, a color filter 140, and another color filter 142 may be disposed on the insulating layer 136. The shielding member 138 may cover the TFT 124, and the shielding member 138 may be a portion of the black matrix layer, but not limited thereto. The color filter 140 and the color filter 142 may have different colors. For example, the color filter 140 may be green and the color filter 142 may be red, but not limited thereto. A first electrode 144 may be disposed on the color filter 142, and a second electrode 146 may be disposed on the first electrode 144. An insulating layer 148 may be disposed between the first electrode 144 and the second electrode 146, and the first electrode 144 may be electrically connected to the drain electrode 132 by a via penetrating through the insulating layer 136. The first electrode 144 may be one of the pixel electrode and the common electrode, and the second electrode 146 may be the other one of the pixel electrode and the common electrode. FIG. 3 shows that the black matrix layer and the color filter layer are disposed on the inner surface of first flexible substrate 102. Thus, the liquid crystal display 100 shown in FIG. 3 may be a color filter on array substrate (COA) or black matrix on array substrate (BOA) structure, but not limited thereto. In some embodiments, although not shown, the black matrix layer and/or the color filter layer can be disposed on an inner surface 104b of the second flexible substrate 104. The inner surface 104b means the surface facing toward the interior of the display panel 100C and facing to the liquid crystal layer 106, and an outer surface 104a of the second flexible substrate 104 means the surface away from the liquid crystal layer 106. The outer surface 104a is opposite to the inner surface 10b.

In addition, a cover layer 150 and another polarizing layer 152 may be disposed on the outer surface 104a of the second flexible substrate 104, and the polarizing layer 152 may be disposed between the second flexible substrate 104 and the cover layer 150, but not limited thereto. A spacer 154, the liquid crystal layer 106, and the sealant 110 may be disposed between the first flexible substrate 102 and the second flexible substrate 104. For example, the spacer 154 may be disposed corresponding to the shielding member 138 and between the second flexible substrate 104 and the insulating layer 148, and the sealant 110 may be disposed between the second flexible substrate 104 and the insulating layer 136, but not limited thereto. In addition, an alignment layer 156 may be disposed between the liquid crystal layer 106 and the first flexible substrate 102, and the alignment layer 156 may also be disposed between the liquid crystal layer 106 and the second flexible substrate 104.

In addition, the liquid crystal display 100 may be fringe field switching (FFS) type liquid crystal display, but not limited thereto. In some embodiments, the liquid crystal display 100 may be vertical alignment (VA) type, in-plane-switching (IPS) type, or other types of liquid crystal displays. The liquid crystal display 100 (or the electronic device ED) mentioned above or shown in FIG. 3 is an illustration, and therefore the number, size, or location of each component is not limited to the content of the above description or FIG. 3.

The electronic device or the liquid crystal display of the present disclosure are not limited by the aforementioned embodiment, and may have other different embodiments and variant embodiments. To simplify the description, identical components in each of the following embodiments are marked with identical symbols. For making it easier to compare the difference between the embodiments, the following description will detail the dissimilarities among different embodiments and the identical features will not be redundantly described.

Referring to FIG. 4, it is a side-view schematic diagram illustrating an electronic device or a liquid crystal display according to a second embodiment of the present disclosure. In some embodiments, the liquid crystal display 100 (or the electronic device ED) may further include an adhesive material 158 and a backlight module 160. For example, the adhesive material 158 can be an optical glue disposed between the polarizing layer 112 and the first flexible substrate 102. The optical film 108 may be adhered to the first flexible substrate 102 by the optical glue 158. The refractive index of the optical glue 158 may be similar or identical to the refractive index of the polarizing layer 112 or the diffusing layer 114, but not limited thereto. The backlight module 160 may be disposed under the first flexible substrate 102, and the optical film 108 can be disposed between the first flexible substrate 102 and the backlight module 160. In some embodiments, in the liquid crystal display 100, the diffusing layer 114 is integrated in the optical film 108 and adhered to the first flexible substrate 102. That is to say, the diffusing layer 114 is included in the display panel 100C. Therefore, in some embodiments, the backlight module 160 may not include any diffusing layer. However, in some embodiments, the backlight module 160 may include a diffusing layer according to needs.

The backlight module 160 may include a light source 162, alight guide layer 164, and a housing 166, and the light source 162 and the light guide layer 164 may be disposed in the housing 166. The light emitted from the light source 162 can be guided by the light guide layer 164, and the relative position of the light source 162 and the light guide layer 164 is not limited. For example, in some embodiments, as shown in FIG. 4, the backlight module 160 may be an edge-lit type backlight module, and the light source 162 may be disposed near at least one of the sidewalls of the housing 166, but not limited thereto. In some embodiments, the backlight module 160 may be a direct-lit type backlight module (not shown). The light source 162 may include light emitting diode (LED), micro-LED, mini-LED, organic light-emitting diode (OLED), quantum dot light emitting diode (QLED; QDLED), other suitable light sources, or combinations thereof, but not limited thereto. In some embodiments, the backlight module 160 may also include other optical layers, such as reflective layer, dual brightness enhancement film (DBEF), or combinations thereof, but not limited thereto. In some embodiments, the backlight module 160 (and/or the components inside) may not be curved along with the first flexible substrate 102 and/or the optical film 108, and a curvature radius of the backlight module 160 may be different from a curvature radius of the optical film 108, but not limited thereto. Such structure is suitable for use in various devices, such as televisions, automotive displays, vending machines, or automated teller machine (ATM), in which the total thickness of the device is less concerned. In such situation, the distance between the optical film 108 and the backlight module 160 can be in a range of 0.5 cm to 1 m, for example, in a range of 1 cm to 1 m, or in a range of 2 cm to 0.5 m.

As shown in FIG. 4, a control element (such as an integrated circuit (IC)) 168 may be disposed on the first flexible substrate 102 and outside the liquid crystal layer 106 and/or the sealant 110, but not limited thereto. The control element 168 may be used for driving the liquid crystal display 100 to display images, but not limited thereto. Additionally, the control element 168 may overlap with the optical film 108 in the normal direction V, and therefore the optical film 108 can provide better supporting function to the first flexible substrate 102 and/or the control element 168.

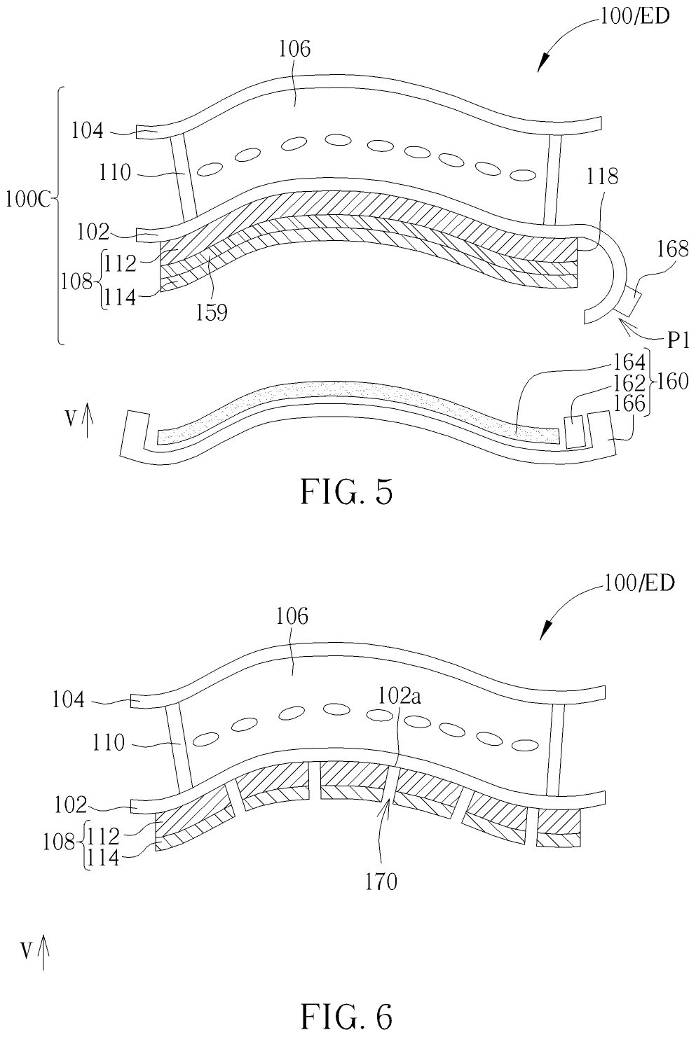

Referring to FIG. 5, it is a side-view schematic diagram illustrating an electronic device or a liquid crystal display according to a third embodiment of the present disclosure. In some embodiments, an adhesive material 159 may be disposed between the polarizing layer 112 and the diffusing layer 114. The adhesive material 159 can be an optical glue. The diffusing layer 114 may be adhered to the polarizing layer 112 by the optical glue 159. Although not shown in FIG. 5, the optical glue 158 as shown in FIG. 3 can also be adhered between the first flexible substrate 102 and the polarizing layer 112. The optical glue 158 and the optical glue 159 can be the same or different. In some embodiments, the backlight module 160 (and/or the components inside) may be curved along with the first flexible substrate 102 and/or the optical film 108, and a curvature radius of the backlight module 160 may be substantially equal to a curvature radius of the optical film 108, but not limited thereto. For example, the light guide layer 164 and/or other optical layers (not shown) in the backlight module 160 may be curved along with the optical film 108, and a curvature radius of the light guide layer 164 (and/or other optical layers) may be substantially equal to the curvature radius of the optical film 108. Accordingly, the brightness uniformity of the liquid crystal display 100 may be further improved. By the curvature matching design, such structure is suitable for use in mobile display devices, such as mobile phones, in which the total thickness of the device is more concerned. Thus, the appearance of the entire liquid crystal display 100 can have uniform curvature. In such situation, the distance between the optical film 108 and the backlight module 160 can be less than or equal to 10 mm, for example, in a range of 0 to 10 mm, or in a range of 0.1 mm to 8 mm, or in a range of 0.1 mm to 5 mm.

Still referring to FIG. 5, in addition, on one side of the liquid crystal display 100, a portion P1 of the first flexible substrate 102 may be protruded from the optical film 108. In detail, for example, the edge 116 of the first flexible substrate 102 can be protruded out of the edge 118 of the optical film 108. In some embodiments, the control element 168 may be disposed on the protruded portion P1 of the first flexible substrate 102. In some embodiments, a part of the protruded portion P1 may be folded. In some embodiments, a part of the protruded portion P1 may be folded backwardly to the rear side of the first flexible substrate 102, for example, to the rear side of the light guide layer 164 and the rear side of the light source 162. In some embodiments, a part of the protruded portion P1 may be folded backwardly to be between the light guide layer 164 and the housing 166. In some embodiments, a part of the protruded portion P1 may be folded backwardly to the rear side of the housing 166. Additionally, the control element 168 may overlap with the optical film 108 in the normal direction V, but not limited thereto. Accordingly, the control element 168 will not occupy the front side (or the displaying side) of the liquid crystal display 100, and the area of the peripheral region may be reduced.

Referring to FIG. 6, it is a side-view schematic diagram illustrating an electronic device or a liquid crystal display according to a fourth embodiment of the present disclosure. The difference between this embodiment and the first embodiment is that the optical film 108 of this embodiment may include a plurality of openings 170, and each of the plurality of openings 170 may penetrate at least a portion of the optical film 108. In some embodiments, as shown in FIG. 6, at least one of the openings 170 may penetrate through the diffusing layer 114 and the polarizing layer 112, and may expose a portion of the outer surface 102a of the first flexible substrate 102, but not limited thereto. In some embodiments, although not shown in figures, at least one of the openings 170 may penetrate through the diffusing layer 114 but may not penetrate the polarizing layer 112, and may expose a portion of the surface of the polarizing layer 112. In some embodiments, the opening 170 may be a concave portion formed in the diffusing layer 114, but not penetrating the diffusing layer 114. In some embodiments, the opening 170 may penetrate the diffusing layer 114, but remaining some portions of the polarizing layer 112 and not penetrating polarizing layer 112. In addition, in some embodiments, the openings 170 in one liquid crystal display 100 may have different patterns. For example, although not shown in figures, in one liquid crystal display 100, some openings 170 may penetrate the diffusing layer 114 and the polarizing layer 112, and some openings 170 may penetrate the diffusing 114 but not penetrate the polarizing layer 112. In some embodiments, the openings 170 may improve the flexibility of the optical film 108 and/or the liquid crystal display 100.

In addition, a filling layer (not shown) may be optionally formed on the optical film 108 and fill into the openings 170. The filling layer may comprise flexible material, elastic material, or combinations thereof. The filling layer can have the refractive index similar or identical to the refractive index of the optical film 108. In some embodiments, the filling layer can have high transparency, for example, can have transparency equal to or higher than 80%.

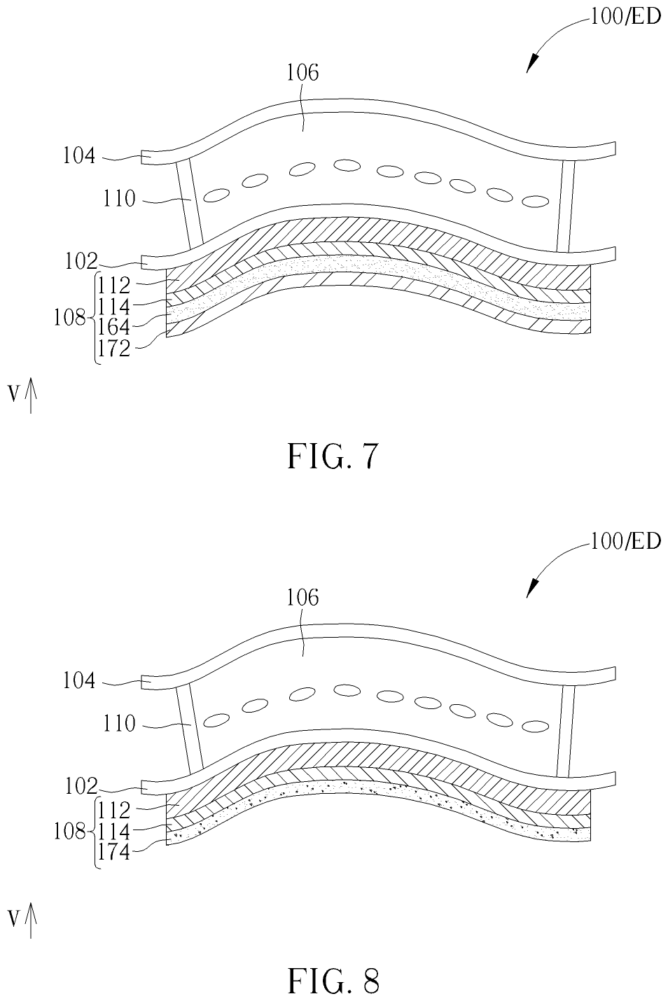

Referring to FIG. 7, it is a side-view schematic diagram illustrating an electronic device or a liquid crystal display according to a fifth embodiment of the present disclosure. The difference between this embodiment and the first embodiment is that the optical film 108 of this embodiment may further include other optical layers, for example, a light guide layer 164 and/or a reflective layer 172. The light guide layer 164 may be adhered to the diffusing layer 114, and the reflective layer 172 may be adhered to the light guide layer 164. The polarizing layer 112, the diffusing layer 114, the light guide layer 164, and the reflective layer 172 may be adhered together and integrated as the optical film 108. The integrated optical film 108 can be adhered to the first flexible substrate 102 of the display panel 100C. Therefore, when the display panel 100C is curved, the integrated optical film 108 (including the polarizing layer 112, the diffusing layer 114, the light guide layer 164, and the reflective layer 172) may be curved along with the first flexible substrate 102. In some embodiments, a curvature radius of the first flexible substrate 102 may be substantially equal to a curvature radius of the optical film 108. In some embodiments, a curvature radius of the first flexible substrate 102 may be substantially equal to a curvature radius of the diffusing layer 114 and/or a curvature radius of the polarizing layer 112 and/or a curvature radius the diffusing layer 114, and/or a curvature radius of the light guide layer 164. Thus, the brightness uniformity of the liquid crystal display 100 can be improved. In some embodiments, the optical film 108 may also include other optical layers, such as DBEF (dual brightness enhancement film). The DBEF can be adhered to the reflective layer 172, but not limited thereto. In the multiple layer structure of the optical film 108, one layer can be adhered to another layer by an adhesive material. The adhesive materials that are used for adhering different layers can be the same or different.

Referring to FIG. 8, it is a side-view schematic diagram illustrating an electronic device or a liquid crystal display according to a sixth embodiment of the present disclosure. The difference between this embodiment and the first embodiment is that the optical film 108 of this embodiment may further include a functional layer 174. The functional layer 174 can provide functions, for example, optical function, structural function, and/or stress function. For example, the functional layer 174 can provide stress function and can be a stress layer. The polarizing layer 112 and the diffusing layer 114 may be disposed between the stress layer 174 and the first flexible substrate 102, and the stress layer 174 may be adhered to the diffusing layer 114, but not limited thereto. The stress layer 174 may comprise metal oxide or plastic material (such as PET), but not limited thereto. The stress layer 174 may balance the stress induced in the optical film 108 and/or the first flexible substrate 102. In some embodiments, the stress layer 174 may be replaced by other types of layers that can provide functions different from the stress layer 174. In addition, in some embodiments, when the polarizing layer 112 and the diffusing layer 114 generate a net compressive stress, one can choose a stress layer 174 with tensile stress, thus balancing the overall stress. Similarly, when the polarizing layer 112 and the diffusing layer 114 generate a net tensile stress, one can choose a stress layer 174 with compressive stress, thus balancing the overall stress. In some embodiments, the stress layer 174 can also have brightness enhancement function and/or polarizing function. In some embodiments, the functional layer 174 can be a single layer, or a multiple layers. For example, the layers included in the functional layer 174 can be in a range of 2 to 20 layers.

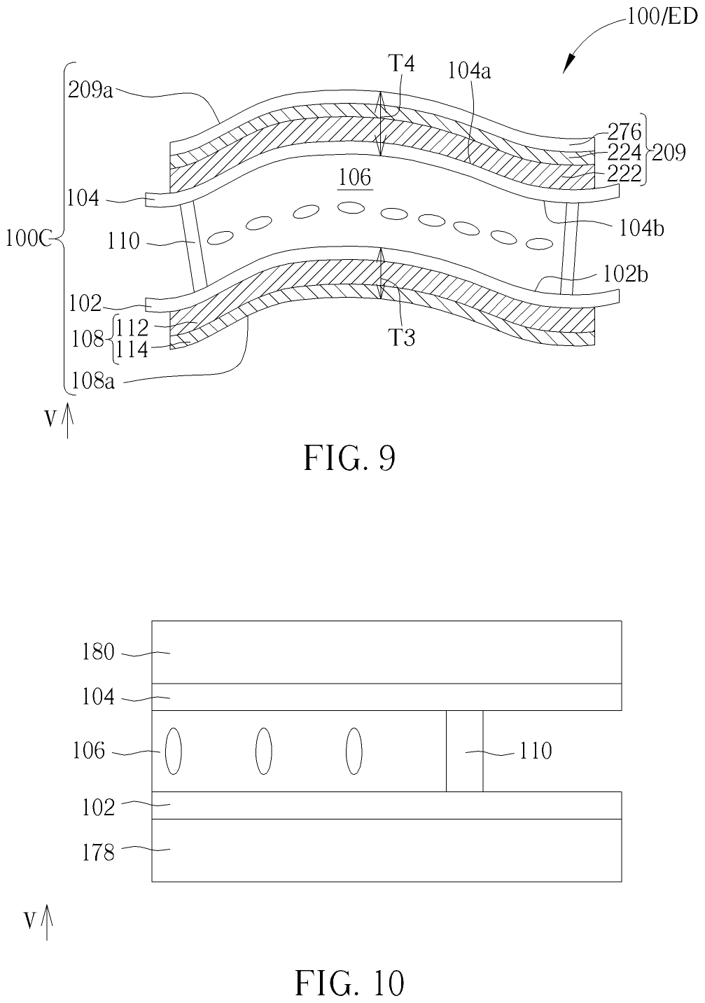

Referring to FIG. 9, it is a side-view schematic diagram illustrating an electronic device or a liquid crystal display according to a seventh embodiment of the present disclosure. The difference between this embodiment and the first embodiment is that the liquid crystal display 100 (or the electronic device ED) of this embodiment may further include another optical film 209 adhered to the second flexible substrate 104, for example, adhered to the outer surface 104a of the second flexible substrate 104. The first flexible substrate 102 and the second flexible substrate 104 may be disposed between the optical film 108 and the another optical film 209. In some embodiments, the optical film 209 can be a single layer or multiple layers. In some embodiments, the optical film 209 can include a polarizing layer. In some embodiments, the structure of the optical film 108 and the structure of the optical film 209 may be different. For example, as shown in FIG. 9, the optical film 209 may include a polarizing layer 222, a diffusing layer 224, and a functional layer 276. The functional layer 276 can provide functions, for example, optical function, structural function, and/or stress function.

For example, the functional layer 276 can provide stress function and can be a stress layer. The numbers and/or materials of layers included in the optical film 108 and the optical film 209 may be different. In some embodiments, the stresses induced in the optical film 108 and the optical film 209 may be different. In some embodiments, coefficients of thermal expansion (CTE) of layers in the optical film 108 and the optical film 209 may be different. In some embodiments, thicknesses, refractive indexes, and/or transmittances of the optical film 108 and the optical film 209 may be different. A first total thickness (T3) is defined as a thickness from the inner surface 102b of the first flexible substrate 102 to an outer surface 108a of the optical film 108, a second total thickness (T4) is defined as a thickness from the inner surface 104b of the second flexible substrate 104 to an outer surface 209a of the optical film 209. In some embodiments, a ratio of the first total thickness (T3) to the second total thickness (T4) is in a range from 0.5 to 1.5, and meet the following relationship 0.5≤T3/T4≤1.5), but not limited thereto. By means of such thickness design, the stress generated from the two substrates can be balanced.

In addition, in some embodiments, the functional layer 276 can be a stress layer. The stress layer 276 can balance the stress in the optical film 209. In some embodiments, the stress layer 276 can balance the stress in the two substrates. For example, by means of the stress layer 276, the neutral stress layer can be adjusted to be in the electrode layer in the TFT 124, thus, the electrode layer will not be affected or be less affected by the stress. In addition, the functional layer 276 can also have structural function, for example, function as anti-impact, buffering effect, or supporting the second flexible substrate. In some embodiments, the functional layer 276 can have optical function, for example, can be an optical compensation layer. In some embodiments, the functional layer 276 can be a single layer or multiple layers. For example, the layers included in the functional layer 276 can be in a range of 2 to 20 layers.

Referring to FIGS. 10-12, FIGS. 10-12 are schematic diagrams illustrating a method of manufacturing an electronic device or a liquid crystal display according to an eighth embodiment of the present disclosure. For example, the method of this embodiment may be used for manufacturing the liquid crystal display 100 (or the electronic device ED) of the seventh embodiment (shown in FIG. 9), but not limited thereto. Firstly, a first step may be performed as shown in FIG. 10, wherein a cell process may be performed to form a cell in the first step. For example, the cell may include the first flexible substrate 102, the second flexible substrate 104, the liquid crystal layer 106, the sealant 110, a first glass substrate 178, and a second glass substrate 180, but not limited thereto. The liquid crystal layer 106 and the sealant 110 may be disposed between the first flexible substrate 102 and the second flexible substrate 104. The first flexible substrate 102 may be adhered to the first glass substrate 178, and the second flexible substrate 104 may be adhered to the second glass substrate 180. The glass substrates may provide supporting and/or protecting functions to the flexible substrates during the manufacturing process.

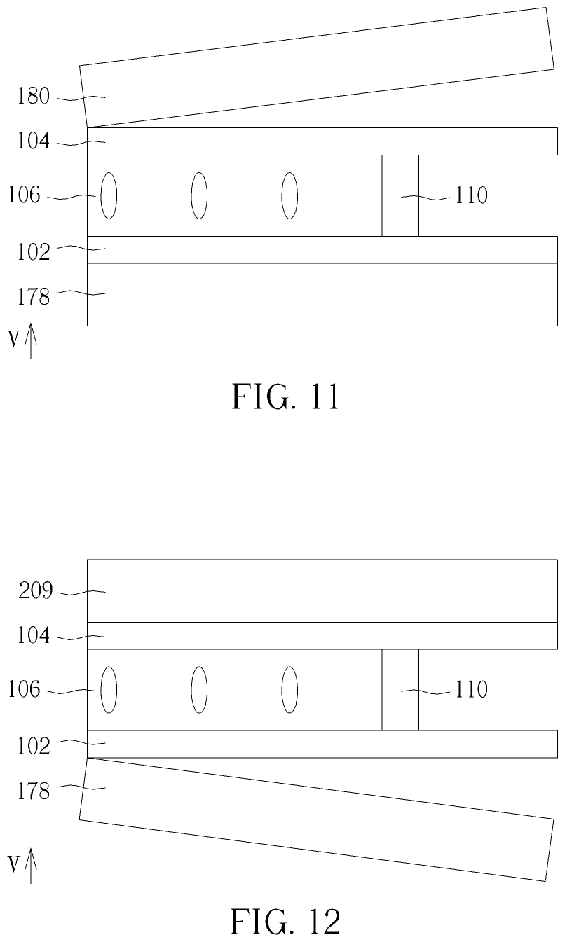

Next, as shown in FIG. 11, the second glass substrate 180 may be lifted off in a second step, and the first glass substrate 178 may be still adhered to the first flexible substrate 102, but not limited thereto. Next, a third step may be performed as shown in FIG. 12, an optical film 209 may be adhered to the second flexible substrate 104. Then, the first glass substrate 178 may be lifted off after the lamination of the optical film 209 is completed. Next, the optical film 108 may be adhered to the first flexible substrate 102, and the display panel 100C shown in FIG. 9 may be obtained.

According to some embodiments, in the flexible or curved liquid crystal display or the flexible or curved electronic device of the present disclosure, the diffusing layer may be adhered to the polarizing layer and integrated into an optical film, and the optical film may be adhered to the first flexible substrate. When the display panel is curved, the diffusing layer and the polarizing layer in the optical film may be curved along with the first flexible substrate, and the curvature radius of the first flexible substrate may be substantially equal to the curvature radius of the optical film. Therefore, in some embodiments, problems such as peeling, misalignment, or uneven gaps between layers may be reduced, and the brightness uniformity of the flexible liquid crystal display may be improved.

Those skilled in the art will readily observe that numerous modifications and alterations of the device and method may be made while retaining the teachings of the disclosure. Accordingly, the above disclosure should be construed as limited only by the metes and bounds of the appended claims.

1. A flexible electronic device, comprising:
a first flexible substrate; and
an optical film adhered to the first flexible substrate, comprising a functional layer,
wherein a Young's modulus of the optical film is greater than a Young's modulus of the first flexible substrate.

2. The flexible electronic device according to claim 1, wherein the functional layer comprises at least one of an optical function, a structural function, and a stress function.

3. The flexible electronic device according to claim 1, wherein the optical film is adhered to the first flexible substrate by an optical glue.

4. The flexible electronic device according to claim 1, wherein the optical film is adhered to the first flexible substrate by coating.

5. The flexible electronic device according to claim 1, wherein a thickness of the optical film is greater than or equal to a thickness of the first flexible substrate.

6. (canceled)

7. The flexible electronic device according to claim 1, wherein an area of the first flexible substrate is different from an area of the optical film.

8. The flexible electronic device according to claim 7, wherein a ratio of the area of the first flexible substrate to the area of the optical film is greater than 1 and less than or equal to 1.2.

9. The flexible electronic device according to claim 1, wherein the first flexible substrate has a first edge, the optical film has a second edge adjacent to the first edge, and a distance between the first edge of the first flexible substrate and the second edge of the optical film is in a range from 0.5 millimeters to 5 centimeters.

10. The flexible electronic device according to claim 1, wherein a curvature radius of the first flexible substrate is substantially equal to a curvature radius of the optical film.

11. (canceled)

12. The flexible electronic device according to claim 1, comprising a light source.

13. The flexible electronic device according to claim 12, wherein the light source comprises a light emitting diode (LED), a micro-LED, a mini-LED, an organic light-emitting diode (OLED), or a quantum dot light emitting diode (QLED, QDLED).

14. The flexible electronic device according to claim 1, comprising a second flexible substrate and a liquid crystal layer, wherein the liquid crystal layer is disposed between the first flexible substrate and the second flexible substrate.

15. (canceled)

16. (canceled)

17. The flexible electronic device according to claim 2, wherein the functional layer comprises a stress layer or an optical compensation layer.

18. The flexible electronic device according to claim 14, further comprising another optical film adhered to the second flexible substrate, wherein the first flexible substrate and the second flexible substrate are disposed between the optical film and the another optical film.

19. The flexible electronic device according to claim 18, wherein a first total thickness is defined as a thickness from an inner surface of the first flexible substrate to an outer surface of the optical film, a second total thickness is defined as a thickness from an inner surface of the second flexible substrate to an outer surface of the another optical film, and a ratio of the first total thickness to the second total thickness is in a range from 0.5 to 1.5.

20. The flexible electronic device according to claim 1, wherein the optical film comprises a plurality of openings, wherein at least one of the plurality of openings penetrates at least a portion of the optical film.
